(19) United States
(12) Patent Application Publication
(10) Pub. No.: US 2026/0310132 A1
(43) Pub. Date: Oct. 8, 2026

(54) Hologram Replicator

(71) Applicant: Envisics Ltd, Milton Keynes (GB)

(72) Inventors: Timothy Smeeton, Milton Keynes (GB); Ruisheng Lin, Milton Keynes (GB)

(21) Appl. No.: 19/483,485

(22) PCT Filed: May 16, 2024
(86) PCT No.: PCT/EP2024/063555

§ 371 Date: Nov. 11, 2025

(30) Foreign Application Priority Data
May 25, 2023 (GB) 2307845.4

(51) Int. Cl. G03H 1/30; G02B 27/01; G03H 1/26

(52) U.S. Cl. CPC G03H 1/30; G02B 27/0103; G02B 2027/0105; G03H 2001/261

(57) ABSTRACT

There is disclosed herein a holographic display system having a viewing window. The display system comprises a hologram replicator and a hologram engine. The hologram replicator is arranged to waveguide a holographic wavefront between a pair of reflective surfaces. A first reflective surface is partially transmissive such that a plurality of replicas of the holographic wavefront are emitted therefrom. The hologram engine is arranged to output holograms. Each hologram is configured to distribute picture content of a corresponding picture by angle such that a spatial coordinate in the picture corresponds to an angle in a holographic wavefront formed from the hologram. The hologram engine is further arranged to determine a plurality of sub-holograms of the picture and nullify an area of each sub-hologram. Each sub-hologram corresponds to a different zone of the picture. A size of the nullified area is different for each sub-hologram.

### FIELD

The present disclosure relates to a display system and method of display. More specifically, the present disclosure relates to a holographic display and method of holographic image formation. Yet more specifically, the present disclosure relates to a holographic projector such as an augmented reality holographic projector, a method of hologram replication and a method of replicating a holographic wavefront for pupil expansion. Some embodiments relate to a head-up display.

### BACKGROUND AND INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device.

The spatial light modulator may be reflective meaning that modulated light is output in (holographic) direflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other embodiments, the image is a real image formed by holographic reconstruction and the image is projected or relayed to the viewing plane. The image is formed by illuminating a diffractive pattern (e.g., hologram) displayed on the display device.

The display device comprises pixels. The pixels of the display device may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some examples, an image (formed from the displayed diffractive pattern/hologram) is propagated to the eyes. For example, spatially modulated light of an intermediate holographic reconstruction/image formed either in free space or on a screen or other light receiving surface between the display device and the viewer, may be propagated to the viewer.

In embodiments, the image is a real image. In other embodiments, the image is a virtual image that is perceived by a human eye (or eyes). The projection system, or light engine, may thus be configured so that the viewer looks directly at the display device. In such embodiments, light encoded with the hologram is propagated directly to the eye(s) and there is no intermediate holographic reconstruction formed, either in free space or on a screen or other light receiving surface, between the display device and the viewer. In such embodiments, the pupil of the eye may be regarded as being the entrance aperture of the viewing system and the retina of the eye may be regarded as the viewing plane of the viewing system. It is sometimes said that, in this configuration, the lens of the eye performs a hologram-to-image conversion.

In some other examples, the (light of a) diffractive pattern/hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-motion box.)

In some embodiments, the image perceived by a viewer is a virtual image that appears upstream of the display device—that is, the viewer perceives the image as being further away from them than the display device. Conceptually, it is possible to consider a plurality of different virtual image points of a virtual image. The distance from a virtual point to the viewer is referred to herein as a virtual image distance, for that virtual image point. Different virtual points may, of course, have different virtual image distances. Individual light rays, within ray bundles associated with each virtual point, may take different respective optical paths to the viewer, via the display device. However, only some parts of the display device, and therefore only some of the rays from one or more virtual points of a virtual image, may be within the user's field of view. In other words, only some of the light rays from some of the virtual points on the virtual image will propagate, via the display device, into the user's eye(s) and thus will be visible to the viewer. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two—orders of magnitude greater than the diameter, or width, of the entrance pupil and/or aperture of the display device (i.e., size of the array of pixels). Embodiments of the present disclosure relate to a configuration in which a hologram of an image is propagated to the human eye rather than the image itself. In other words, the light received by the viewer is modulated according to (or encoded with/by) a hologram of the image. However, other embodiments of the present disclosure may relate to configurations in which the image is propagated to the human eye rather than the hologram—for example, by so called indirect view, in which light of a holographic reconstruction or “replay image” formed on a screen (or even in free space) is propagated to the human eye.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two—orders of magnitude greater than the diameter, or width, of the entrance pupil and/or aperture of the display device (i.e., size of the array of pixels). Embodiments of the present disclosure relate to a configuration in which a hologram of an image is propagated to the human eye rather than the image itself. In other words, the light received by the viewer is modulated according to (or encoded with/by) a hologram of the image. However, other embodiments of the present disclosure may relate to configurations in which the image is propagated to the human eye rather than the hologram—for example, by so called indirect view, in which light of a holographic reconstruction or “replay image” formed on a screen (or even in free space) is propagated to the human eye.

A waveguide is used to expand the field of view and therefore increase the maximum propagation distance over which the full diffractive angle of the display device may be used. Use of a waveguide can also increase the user's eye-box laterally, thus enabling some movement of the eye(s) to occur, whilst still enabling the user to see the image. The waveguide may therefore be referred to as a waveguide pupil expander.

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure relates to non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window—e.g., eye-box or eye motion box for viewing by the viewer. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

In some embodiments, the first pair of opposing surfaces of the waveguide are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram or point cloud hologram. The use of diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field (e.g. diffracted light comprising diverging (not collimated) ray bundles).

In aspects, the display system comprises a display device—such as a pixelated display device, for example a spatial light modulator (SLM) or Liquid Crystal on Silicon (LCOS) SLM which is arranged to provide or form the diffracted (e.g. diverging) light. In such aspects, the aperture of the spatial light modulator (SLM) is a limiting aperture of the system. That is, the aperture of the spatial light modulator—more specifically, the size of the area delimiting the array of light modulating pixels comprised within the SLM—determines the size (e.g.

spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The diffracted (e.g. diverging) light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field-including some of, preferably most of, preferably all of, the replicas of the light field that are output by the first waveguide pupil expander-from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated (e.g. rod shaped) and the second waveguide pupil expander may be substantially planar (e.g. rectangular-shaped). The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

In order to provide suitable launch conditions to achieve internal reflection within the first and second waveguide pupil expanders, an elongate dimension of the first waveguide pupil expander may be tilted relative to the first and second dimensions of the second waveguide pupil expander.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments-described only by way of example of a diffracted or holographic light field in accordance with this disclosure-a hologram is configured to route light into a plurality of channels, each channel corresponding to a different part (i.e. sub-area) of an image. The hologram may be represented, such as displayed, on a display device such as a spatial light modulator. When displayed on an appropriate display device, the hologram may spatially modulate light transformable by a viewing system into the image. The channels formed by the diffractive structure (comprising the hologram) are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram is described herein as routing light into a plurality of hologram channels merely to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically, the hologram divides the image content by angle. That is, each point on the image is associated with a unique light ray angle in the spatially modulated light formed by the hologram when illuminated—at least, a unique pair of angles because the hologram is two-dimensional. The spatially modulated light formed by this type of hologram, when illuminated, may be arbitrarily divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels. However, in some arrangements, a plurality of spatially separated hologram channels is formed by intentionally leaving areas of the target image, from which the hologram is calculated, blank or empty (i.e., no image content is present).

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the (special type of) hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

Broadly, a system is disclosed herein that provides pupil expansion for an input light field, wherein the input light field is a diffracted or holographic light field comprising diverging ray bundles. As discussed above, pupil expansion (which may also be referred to as “image replication” or “replication” or “pupil replication”) enables the size of the area at/from which a viewer can see an image (or, can receive light of a hologram, which the viewer's eye forms an image) to be increased, by creating one or more replicas of an input light ray (or ray bundle). The pupil expansion can be provided in one or more dimensions. For example, two-dimensional pupil expansion can be provided, with each dimension being substantially orthogonal to the respective other.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffractive or diffracted light may be output by a display device such as a pixelated display device such as a spatial light modulator (SLM) arranged to display a diffractive structure such as a hologram. The diffracted light field may be defined by a “light cone”. Thus, the size of the diffracted light field (as defined on a two-dimensional plane) increases with propagation distance from the corresponding diffractive structure (i.e. display device).

The spatial light modulator may be arranged to display a hologram (or a diffractive pattern comprising a hologram). The diffracted or diverging light may comprise light encoded with/by the hologram, as opposed to being light of an image or of a holographic reconstruction. In such embodiments, it can therefore be said that the pupil expander replicates the hologram or forms at least one replica of the hologram, to convey that the light delivered to the viewer is spatially modulated in accordance with a hologram of an image, not the image itself. That is, a diffracted light field is propagated to the viewer.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

There is disclosed herein the concept of a “virtual surface” or so-called “extended modulator” which comprises a one or two dimensional array of (virtual) replicas of the hologram or display device. The terms “replicas of the display device” and “replicas of the hologram” are used interchangeable herein. Reference is also made herein to replicas of the holographic wavefront but, unless specified to the contrary, the term “replica” should be taken to mean “hologram replica”. The optical path length associated with each hologram replica may be different. This may be because the optical path of different hologram replicas may have a different path length through the waveguide, for example bouncing between surfaces of the first and optional second waveguide with a different number of “bounces”. Thus, the unfolded path length of each replica may be different and so the array of replicas of the virtual surface or extended modulator may be offset from one another. In other words, the plurality of replicas may be “staggered”. Each replica of the display device may be a different perpendicular distance from the display device owing to the different path lengths in the waveguide associated with each replica. For an optical system comprising a first waveguide and a second waveguide, the extended modulator may defined as comprising the following: (i) a first offset between replicas generated in a first waveguide (e.g. an elongate waveguide) defined by an angle (in space) and corresponding direction of pupil expansion, (ii) a second offset between replicas generated in a second waveguide (e.g. planar waveguide) defined by an angle (in space) and corresponding direction of pupil expansion; (iii) any skew between the direction of the first offset and the second offset-creating a general parallelogram if the original display device is rectangular, and/or (iv) an optical path length (difference) between display device replicas and the eye position.

In embodiments, the virtual surface containing the hologram/display device and the plurality of virtual (hologram) replicas is “staggered”. In particular, each replica of the display device/hologram is a different perpendicular distance from the display device owing to the different path lengths in the waveguide associated with each replica. Thus, the part of the virtual surface (e.g. in the x, y dimensions) associated with each replica is offset from the display device in the perpendicular direction (e.g. in the z dimension).

The term “virtual image” is used herein to refer to an image or holographic reconstruction formed upstream of the display device. That is, the display device is between the virtual image and a viewer. In other words, the distance from the virtual image to the viewer is greater than the distance from the display device to viewer. It will be understood by the person skilled in the art of optics that the viewer effectively looks through the display device to see the virtual image. The virtual image may be perceived several metres behind the display device. The person skilled in the art will therefore understand how it may be possible to consider light ray paths from the virtual image, through the display device or an extended surface containing the display device, to a viewer on the other side of the display device.

The prefix “sub” in relation to each hologram of the plurality of sub-holograms formed on the display device and replicas thereof is used merely to distinguish from a hologram of the complete picture and to reflect that each is effectively a component of a composite hologram formed by time-interlacing. The hologram may be a Fourier hologram. The sub-hologram and sub-hologram components may therefore also Fourier sub-holograms or Fourier sub-hologram components, respectively.

As described herein, the waveguide effectively forms an array of replicas of the display device (also called “virtual replicas” herein), wherein each display device replica corresponds to a respective replica of the hologram. The array of replica display devices is referred to herein as a “staggered surface”. The “surface” is not continuous because the replicas are spatially separated in direction normal to the surface of the display device e.g. in the z-direction. The surface is referred to as “staggered” to reflect this changing separation of the different display device replicas in the z-direction. Generally, the display device replicas are on different x, y planes that are spatially offset in the z-direction (in the absence of any skew). In the case of replication in one-dimension using one waveguide, the staggered surface may resemble a series of free-standing steps, wherein the risers of the steps are absent. In the case of replication in two orthogonal directions using two orthogonal waveguides as known in the art of pupil expansion, the staggered surface is effectively staggered in two directions e.g. x and y but there is no surface component in the z-direction. The terms “virtual surface”, “staggered extended modulator” and “extended surface” may also be used herein to refer to the array of replicas of the display device formed by the waveguide.

A step of “unfolding” an optical path within the waveguide may be described with reference to the process of straight-line extrapolating a light ray that exits the waveguide through its output port (i.e. a light ray of a replica) back to the virtual surface without internal reflection within the waveguide. By extrapolating all light rays of a replica back to the virtual surface, a location or position of a corresponding virtual replica of the display device is identified. Each virtual replica of the display device is at a different distance from the viewer because of the different optical path lengths within the waveguide associated with each replica.

When used in the context of a holographic wavefront, the term “replica” reflects that spatially modulated light is divided such that a complex wavefront/light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image-i.e., light that is spatially modulated with a hologram of an image, not the image itself. The person skilled in the art of holography will appreciate that the complex wavefront/light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances—providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic wavefront/light field or a wavefront/light field forming a holographic reconstruction of an image. The holographic light field forms a (holographic) reconstruction of an image on a replay plane. The holographic light field that propagates from the hologram to the replay plane may be said to comprise light encoded with/by the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer (e.g. from a display device to a viewing system). The diffracted light field may form an image.

There is disclosed herein a (holographic) display system having a viewing window (e.g. eye-box). The display system may be a holographic projector. The display system may be part of a head-up display. The display system comprises a (or at least one) hologram replicator and a hologram engine. The hologram replicator is arranged to replicate a hologram in one-direction e.g. the vertical or horizontal direction. The hologram engine may be arranged to calculate or retrieve a hologram of an input or “target”. The input or target may be an image comprising an array of pixels, wherein each has a pixel value. Each hologram replicator effectively increases the size of a pupil of the optical system and therefore viewing window of the display system. The hologram replicator is arranged to waveguide a holographic wavefront between a pair of reflective surfaces. A first reflective surface (of the pair of reflective surfaces) is partially transmissive (or “transflective”) such that a plurality (e.g. array) of replicas of the holographic wavefront are emitted therefrom. The system may comprise two orthogonal hologram replicators that collectively provide 2D replication. The hologram engine is arranged to output holograms. Each hologram is configured (e.g. through the method by which it is calculated) to distribute picture content of a corresponding picture (i.e. target) by angle such that each/every spatial coordinate in the picture uniquely corresponds to a respective angle in a holographic wavefront formed from the hologram (e.g. when the hologram is displayed on a spatial light modulator and illuminated with light having sufficient coherence, as known in the art). The hologram engine is further arranged to determine a plurality of sub-holograms of the picture and nullify an area of each sub-hologram. Each sub-hologram corresponds to a different zone of the picture. A size of the nullified area is different for each sub-hologram.

There is disclosed herein an approach which involves dividing each picture into zones and calculating sub-holograms of each zone. Notably, pixels of the hologram are nullified to address a problem caused by the hologram replicator. Specifically, bands or strips of hologram pixel values are nullified in correspondence with an angular overlap between adjacent hologram replicas. The inventors have identified that this approach can be used to eliminate so-called bright bands in the perceived image formed by the type of hologram disclosed herein—specifically, a hologram that divides picture content in the spatial domain by angle in the hologram domain. The inventors further recognized that, because of the way this type of hologram and replicator work together, the amount of hologram pixel nulling or cropping must be a function of the position of the corresponding zone within the picture otherwise some picture content is not delivered to some viewing positions. The staggered array of hologram replicas results in a varying angular overlap between adjacent replicas. The inventors have devised an approach that addresses all these issues and provides an improved viewing experience that does not rely anything more than identification of a viewing window. For example, some embodiments do not require gaze tracking information. In other words, bright lines (or bands) arise due to pupil expansion by the replicator (or waveguide). A bright line is visible whenever there is an overlap between two adjacent rows of replicas. The thickness of the bright lines are angle dependent in the plane of the direction of the replication. Taking an example with vertical replication, the lines are thinnest at the bottom of the image and thickest at the top of the image. If the vertical replicator (waveguide) coupling angle is adjusted, the thickness of the lines can be changed, but there does not exist such an angle that can correct all bright lines. There will always either be a) thin/no bright lines at the bottom of the image and thick bright lines at the top, or b) thin/no bright lines at the top of the image but dark bands at the bottom. Fundamentally, this is due to the replicas not all being in the same plane.

In overview, bright lines in the perceived image are corrected using pure software correction. In some embodiments, the bright lines are removed from using Fourier hologram which gives better image quality and high compute speed. However, other types of hologram may benefit from the present disclosure. In fact, any hologram that substantially divides the image content (in the spatial domain) by angle (in the hologram domain) will benefit from the present disclosure. Removal of the bright line has been found to significantly improve the viewing experience and perceived image quality.

There is also disclosed herein a display system having a viewing window. The display system comprises a hologram replicator and a hologram engine. The hologram replicator is arranged to waveguide a holographic wavefront between a pair of reflective surfaces. A first reflective surface is partially transmissive such that a plurality of replicas of the holographic wavefront are emitted therefrom. The hologram engine is arranged to determine a plurality of sub-holograms of the picture, wherein each sub-hologram corresponds to a different zone of the picture; and nullify an area of each sub-hologram, wherein a size of the nullified area is different for each sub-hologram.

The zones may evenly divide the picture in a first direction such that an input/target image used to determine each sub-hologram comprises even or uniform strips of pixel values of the corresponding zone and null pixels. It may be said that the null pixels pad the pixel values of the zone to reflect that they surround or adjoin the retained hologram pixel values. The null pixels are pixels having a constant/uniform value that do not contribute to the holographic/diffractive wavefront. For example, the null pixels may have a pixel value of zero or a pixel value equating to zero modulation.

Each nullified area may be a strip or slice of the hologram area extending in the same direction as the zone of the corresponding picture. The strips may be horizontal strips. In some embodiments, the zones of the picture extend horizontally, the nullified areas of the hologram extend in the horizontal direction and the hologram replicator provides replication in the vertical direction. In some embodiments, a size (e.g. height) of the zone of the picture is not the same as the size (e.g. height) of the nullified area. The reader should be careful not to confuse pixel nulling of the picture (that results in zones of picture pixels padded by e.g. zero pixels—in the image domain) and pixel nulling of the corresponding hologram (used to prevent angular overlapping of the diffracted wavefront—in the hologram domain). These are two different processes performed for different reasons based on different factors. The nulling of hologram pixel values is particularly unusual and counter-intuitive.

The size of the nullified area may decrease with each successive zone/division of the picture, or vice versa, such that the first zone corresponds to the largest nullified area and the final zone corresponds the smallest nullified area, or vice versa. The first zone may correspond to e.g. the top of the picture and the last or final zone may correspond to the bottom of the picture, or vice versa. The first zone may additionally or alternatively correspond to the fewest number of internal reflections with the replicator and the final or last zone may correspond to the highest number of internal reflections with the replicator. The viewer uses the full length of the replicator to view the full image. Therefore, In some embodiments, one end of the hologram replicator corresponds to a maximum field of view angle and the other/opposite end corresponds to a minimum field of view angle—in the direction of replication.

Each replica of the holographic wavefront may correspond to a respective hologram replica of a staggered array of hologram replicas formed by the hologram replicator. The staggered array of hologram replicas extends in a first direction. The first direction is the direction of replication of the hologram replicator. The array is staggered because each hologram replicator corresponds to a different optical path length in the hologram replicator. The viewer effectively looks at the general plane (albeit, staggered) of hologram replicas and so each successful replica appears slightly closer than the last owing to the extra pair of reflections within the replicator with each replication. That is, each successive hologram replica of the staggered array of hologram replicas may be closer to the viewing window than the last such that the first replica is furthest from the viewing window and the final replica is closest, or vice versa.

The size of the nullified area may correspond to the size of an angular overlap between adjacent hologram replicas from a viewing position within the viewing window. The angular overlap between adjacent hologram replicas may change with each successive replication. That is, the angular overlap between adjacent hologram replicas may change (e.g. decrease) with optical path length in the replicator. This is due to simple geometry caused by the array of hologram replicas having a staggered or offset configuration. For example, the overlap corresponding to the maximum vertical field of view may be less than the overlap corresponding to the minimum vertical field of view. The minimum overlap may be zero—i.e. no overlap.

The nullified area may comprise no more than 25%, such as less than 20% or even less than 10%, of the pixels of the sub-hologram. A change in the size of the nullified area from one sub-hologram of the picture to the next may correspond to no more than 10%, such as less than 5% or even less than 2%, of the pixels of the sub-hologram.

The hologram replicator may replicate the hologram in a first direction, wherein each successive replica increases the size of a viewing area in the first direction. The first direction may be the vertical direction.

The hologram engine may be arranged to determine a size of the nullified area of each sub-hologram based on a viewing position (e.g. eye position) within the viewing area (e.g. eye-box).

The display system may further comprise a user-tracking system (e.g. eye-tracking system) arranged to determine the viewing position (within the viewing window e.g. eye-box).

The hologram engine may be arranged to output each sub-hologram in turn within the integration time of the eye. That is, the sub-holograms may be time-interlaced. The hologram engine may be arranged to calculate each sub-hologram using an iterative phase retrieval algorithm in order to achieve real-time video frame rates. In some embodiments, the holograms are Fourier holograms.

In a variation, the picture is not divided into a plurality of picture components corresponding to different zones of the picture and, instead, user gaze information is used to dynamically determine the size of the nullified area of the hologram of the (entire) picture based on an identified correlation between an area of the hologram replicator and an area of the picture. A calibration may be used to determine an optimum hologram nullification size based on gaze information.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography. Embodiments relate to the calculation of point cloud holograms—that is, holograms built up using point cloud methods.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image comprising a plurality of image areas (bottom) and corresponding hologram comprising a plurality of hologram components (top);

FIG. 3 shows a hologram characterised by the routing or channelling of holographically encoded light into a plurality of discrete hologram channels;

FIG. 4 shows a system arranged to route the light content of each hologram channel of FIG. 3 through a different optical path to the eye;

FIG. 5 shows a perspective view of a pair of stacked image replicators arranged for expanding a beam in two dimensions;

FIG. 6 shows an example visualisation of an “extended modulator” or “virtual surface” comprising a 3D array including a display device and a plurality of replicas of the display device formed by a waveguide;

FIG. 7 shows the varying overlap of replicas resulting from hologram replication in a vertical direction;

FIG. 8A represents conventional Fourier holography and FIGS. 8B to 8E represent Fourier sub-holograms in accordance with embodiments;

FIG. 9 represents variable hologram cropping or hologram pixel nulling in accordance with embodiment; and

FIG. 10 illustrates the elimination of duplicate angular content in the hologram domain in accordance with embodiments.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between. In describing a time relationship-for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

### Optical Configuration

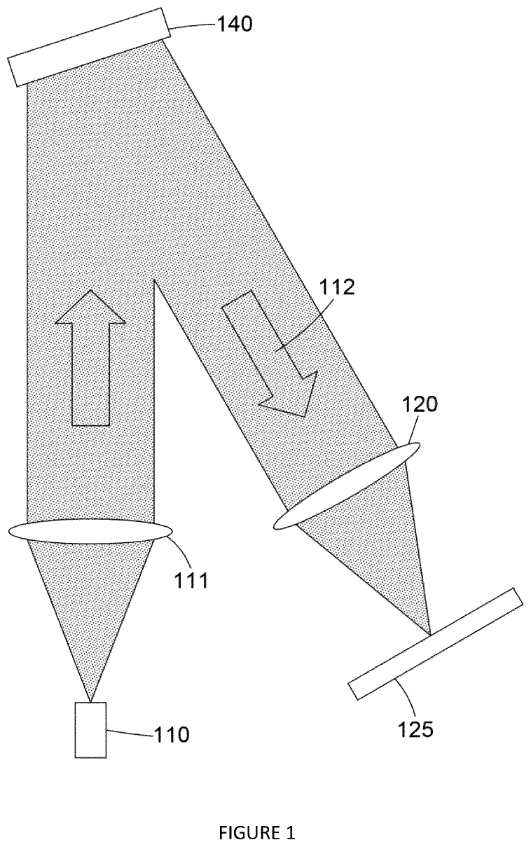

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform.

### Hologram Calculation

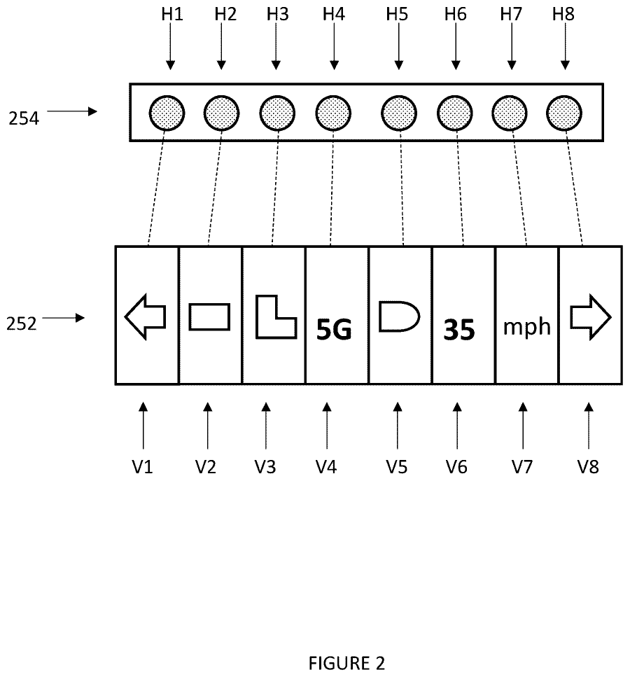

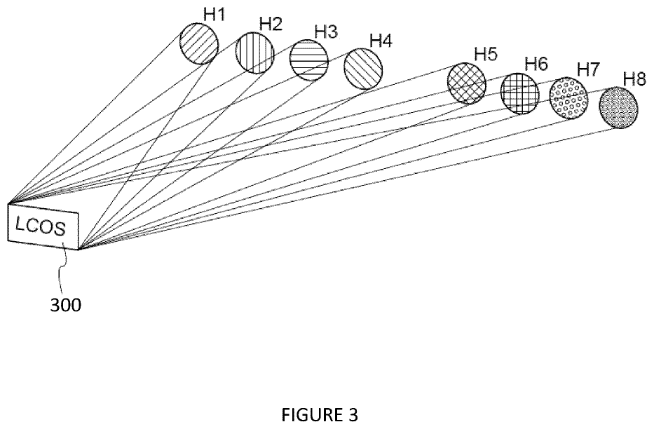

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, embodiments relate to holograms calculated based on point cloud methods. British patent application GB 2112213.0 filed 26 Aug. 2021, incorporated herein by reference, discloses example hologram calculation methods that may be combined with the present disclosure. In particular, the earlier patent application describes methods for calculating a (special) type of hologram, described below with reference to FIGS. 2 and 3, that angularly divides/channels the image content.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Light Modulation

The display system comprises a display device defining the exit pupil of the display system. The display device is a spatial light modulator. The spatial light modulation may be a phase modulator. The display device may be a liquid crystal on silicon, “LCOS”, spatial light modulator as well known in the art. A LCOS SLM comprises a plurality of pixels, such as an array of quadrilateral shaped LC pixels. The pixels may be addressed or encoded with a diffractive pattern comprising a hologram. It may be said that the LCOS SLM is arranged “display” a hologram. The LCOS SLM is arranged to be illuminated with light, and to output spatially modulated light in accordance with the hologram. The spatially modulated light output by the LCOS SLM comprises a diffracted or holographic light field as described herein.

### Light Channelling

The optical system disclosed herein is applicable to pupil expansion with any diffracted light field. In some embodiments, the diffracted light field is a holographic light field—that is, a complex light field that has been spatially modulated in accordance with a hologram of an image, not the image itself. In some embodiments, the hologram is a special type of hologram that angularly divides/channels the image content. This type of hologram is described further herein merely as an example of a diffracted light field that is compatible with the present disclosure. Other types of hologram may be used in conjunction with the display systems and light engines disclosed herein.

A display system and method are described herebelow, which comprise a waveguide pupil expander. As will be familiar to the skilled reader, the waveguide may be configured as a ‘pupil expander’ because it can be used to increase the area over (or, within) which the light emitted by a relatively small light emitter—such as a relatively small SLM or other pixelated display device as used in the arrangements described herein-can be viewed by a human viewer or other viewing system that is located at a distance, such as a relatively large distance, away from the light emitter. The waveguide achieves this by increasing the number of transmission points from which the light is output, towards the viewer. As a result, the light may be seen from a plurality of different viewer locations and, for example, the viewer may be able to move their head, and therefore their line of sight, whilst still being able to see the light from the light emitter. Thus, it can be said that the viewer's ‘eye-box’ or ‘eye-motion box’ is enlarged, through use of a waveguide pupil expander. This has many useful applications, for example but not limited to head-up displays, for example but not limited to automotive head-up displays.

A display system as described herein may be configured to guide light, such as a diffracted light field, through a waveguide pupil expander in order to provide pupil expansion in at least one dimension, for example in two dimensions. The diffracted light field may comprise light output by a spatial light modulator (SLM), such as an LCOS SLM. For example, that diffracted light field may comprise light that is encoded by a hologram displayed by the SLM. For example, that diffracted light field may comprise light of a holographically reconstructed image, corresponding to a hologram displayed by the SL M. The hologram may comprise a computer-generated hologram (CGH) such as, but not limited to, a point-cloud hologram, a Fresnel hologram, or a Fourier hologram. The hologram may be referred to as being a ‘diffractive structure’ or a ‘modulation pattern’. The SLM or other display device may be arranged to display a diffractive pattern (or, modulation pattern) that comprises the hologram and one or more other elements such as a software lens or diffraction grating, in a manner that will be familiar to the skilled reader.

The hologram may be calculated to provide channelling of the diffracted light field. This is described in detail in each of GB2101666.2, GB2101667.0, and GB2112213.0, all of which are incorporated by reference herein. In general terms, the hologram may be calculated to correspond to an image that is to be holographically reconstructed. That image, to which the hologram corresponds, may be referred to as an ‘input image’ or a ‘target image’. The hologram may be calculated so that, when it is displayed on an SLM and suitably illuminated, it forms a light field (output by the SLM) that comprises a cone of spatially modulated light. In some embodiments the cone comprises a plurality of continuous light channels of spatially modulated light that correspond with respective continuous regions of the image. However, the present disclosure is not limited to a hologram of this type.

Although we refer to a ‘hologram’ or to a ‘computer-generated hologram (CGH)’ herein, it will be appreciated that an SLM may be configured to dynamically display a plurality of different holograms in succession or according to a sequence. The systems and methods described herein are applicable to the dynamic display of a plurality of different holograms.

FIGS. 2 and 3 show an example of a type of hologram that may be displayed on a display device such as an SLM, which can be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of the entrance pupil of the viewing system.

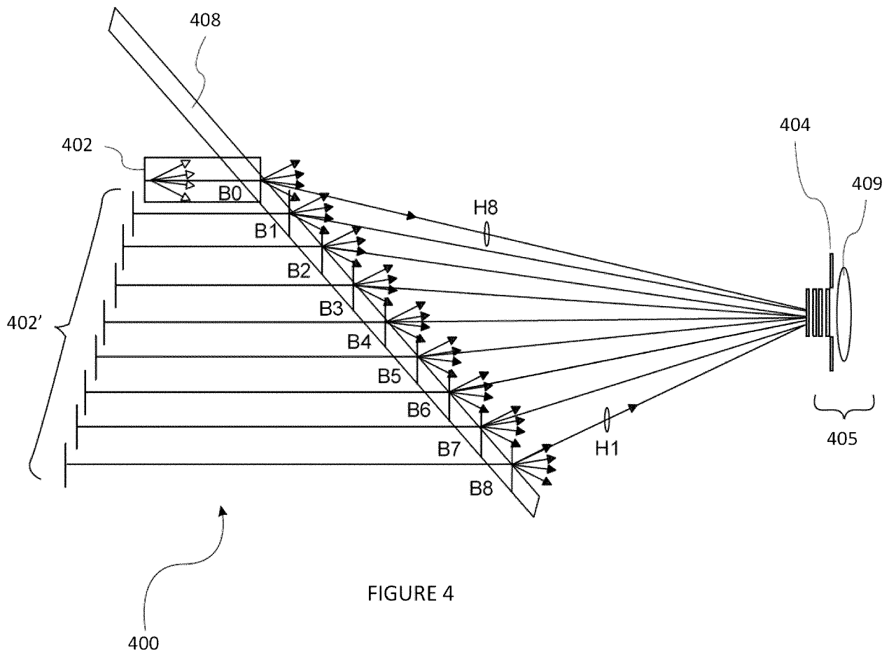

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface.

The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

The methods and arrangements described above can be implemented in a variety of different applications and viewing systems. For example, they may be implemented in a head-up-display (HUD) or in a head or helmet mounted device (HMD) such as an Augmented Reality (AR) HMD.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

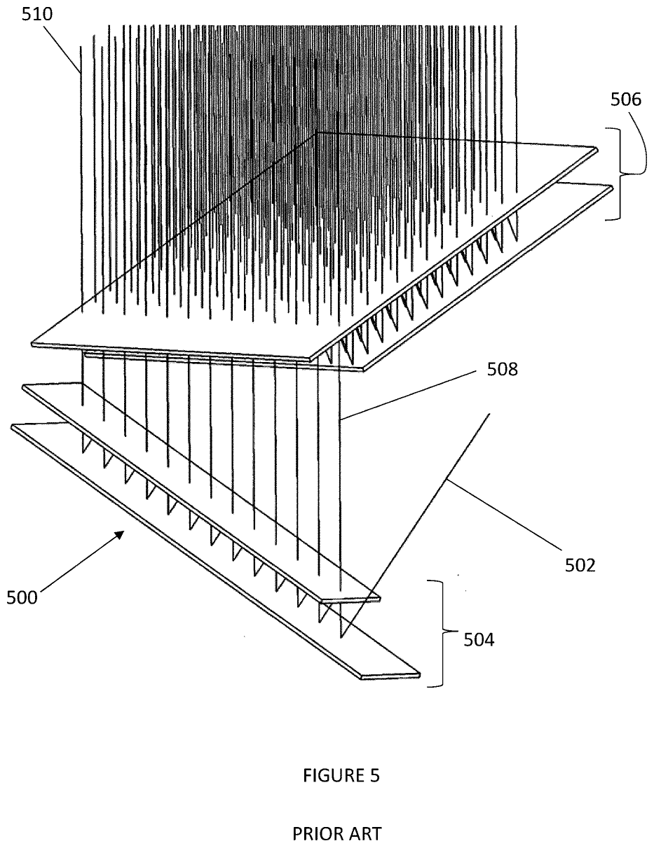

FIG. 5 shows a perspective view of a system 500 comprising two replicators, 504, 506 arranged for expanding a light beam 502 in two dimensions.

In the system 500 of FIG. 5, the first replicator 504 comprises a first pair of surfaces, stacked parallel to one another, and arranged to provide replication- or, pupil expansion-in a similar manner to the waveguide 408 of FIG. 4. The first pair of surfaces are similarly (in some cases, identically) sized and shaped to one another and are substantially elongate in one direction. The light beam 502 is directed towards an input on the first replicator 504. Due to a process of internal reflection between the two surfaces, and partial transmission of light from each of a plurality of output points on one of the surfaces (the upper surface, as shown in FIG. 5), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication- or, pupil expansion-by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams. Thus, it can be said that the first and second replicators 504, 505 of FIG. 5 combine to provide a two-dimensional replicator (or, “two-dimensional pupil expander”).

### Virtual Replicas of the Display Device Formed by the Waveguide or Waveguides

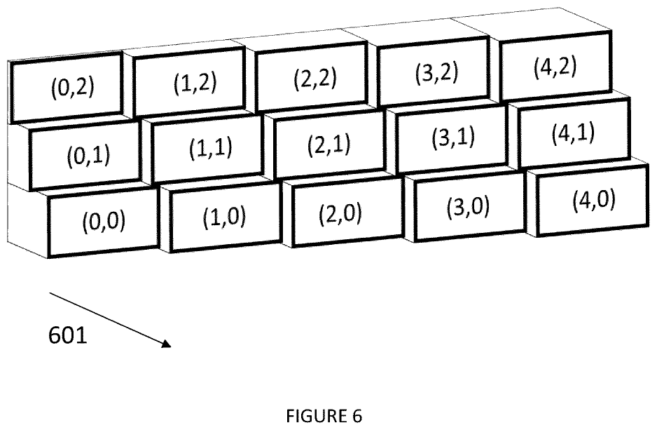

FIG. 6 shows an example visualisation of an “extended modulator” or “virtual surface” comprising a 3D array including a hologram formed on a display device and a plurality of replicas of the hologram formed by a waveguide.

As noted above with reference to FIG. 4, a one-dimensional waveguide 408 may be arranged to expand the exit pupil of a display system. The display system comprises a display device 402 displaying a hologram, which is output at “bounce” point B0 of waveguide 408. In addition, the waveguide forms a plurality of replicas of the hologram, at respective “bounce” points B1 to B8 along its length, corresponding to the direction of pupil expansion.

As shown in FIG. 4, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide.

Thus, the light of the expanded exit pupil may be considered to originate from a virtual surface (also called an “extended modulator” herein) comprising the display device 402 and the replica display devices 402′.

The proposed method of calculating a hologram defines a so-called “extended modulator”, in which the display device (e.g. LCOS SLM) is “extended” by an array of virtual replicas thereof, which would be formed by one or more waveguide pupil expanders, to form an “extended modulator” or “virtual surface” (e.g. as shown in FIG. 4). For example, the display device (e.g. LCOS SLM) may be located at position (0, 0) of the extended modulator shown in FIG. 6, and (virtual) replicas (i.e. replica display devices) that would be formed by two one-dimensional pupil expanders are located at positions extending to (0,2) in a first direction of pupil expansion and (4, 0) in a second direction of pupil expansion. The direction of the optical path is shown by arrow 601, which is perpendicular to the first and second directions of pupil expansion.

Accordingly, an extended modulator is defined comprising: (i) a first offset between replicas generated in a first waveguide pupil expander (e.g. an elongate waveguide) defined by an angle (in space) and corresponding direction of pupil expansion, (ii) a second offset between replicas generated in a second waveguide pupil expander (e.g. planar waveguide) defined by an angle (in space) and corresponding direction of pupil expansion; (iii) any skew between the direction of the first offset and the second offset-creating the general parallelogram shape in FIG. 6, and (iv) the optical path length (difference) between display device replicas and the eye position—in the direction 601 shown in FIG. 6.

### Bright Bands in the Perceived Image

A hologram replicator is used to achieve pupil expansion. The detailed description that follows generally relates to vertical pupil expansion but that is by way of example only. The present disclosure is equally applicable to horizontal pupil expansion, as well as both vertical and horizontal pupil expansion using a pair of orthogonal waveguides.

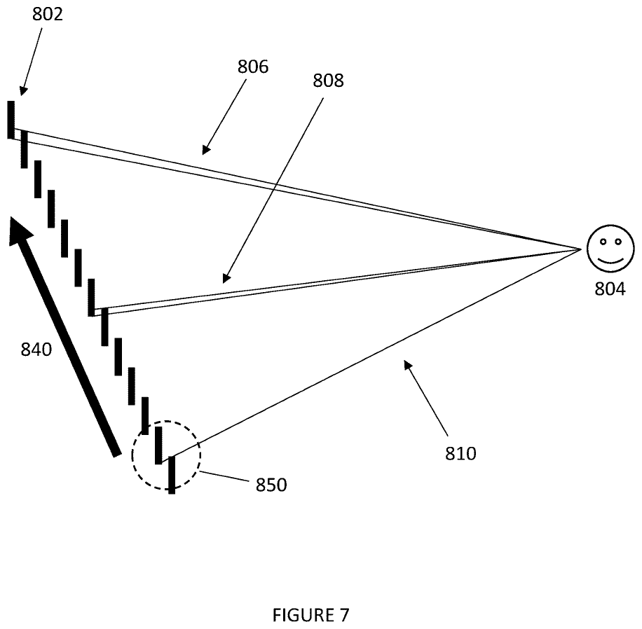

The inventors have found an overlap between adjacent hologram replicas of the extended modulator is advantageous. However, in the overlap region, the same angular components of the image are seen by the eye/detector from both the front and back replicas, resulting in horizontal bright lines in the 3D replica array (see, for example, FIG. 7 described more fully below). Such bright lines are visible to the eye even though the replica plane is separated from the image plane and will affect the image quality perceived by the viewer.

An optimal configuration of waveguide alignment is that when looking down at the maximal (negative) field of view angle, there is just no overlap between the first two replicas—and, from bottom to top, the overlap regions or thickness of the bright lines increase. Such configuration guarantees no horizontal dark bands/gaps between replica rows while maximizing pixel utilization of the modulator.

Since the bright lines originate from the overlap of replicas, it is possible to removed them by turning off a certain range of angles from certain region of display pixels, i.e. allowing the eye to see the angles either from the front or back replica, but not from both. A point-cloud based hologram algorithm may be used to ray trace to determine which angles should come from which pixels, and disable unnecessary pixels from diffracting light in those angle. However, this method often suffers from relatively slow speed due to the complexity of the ray trace, as well as limited number of points in the holographic reconstruction. Embodiments of the present disclosure relate to an iterative phase retrieval algorithm by way of example only of an approach that can be used to differently address the same problem in a way that is less resource demanding.

FIG. 7 shows an extended modulator 802 comprises an array of hologram replicas formed by a waveguide in accordance with the present disclosure. In some embodiments, at least some of the replicas are partially overlapping. In some embodiments, the viewer 804 receives at least some light from substantially all of the extended modulator 802. In some embodiments, each replica contributes to each viewing position within a viewing window. That is, substantially all of the replicas contribute at least some light to each viewing position within the viewing window.

FIG. 7 further shows that, owing to the simple geometry of the arrangement, the degree of overlap, as perceived by the viewer 804, increases 840 from one side (lower extremity in FIG. 7) of the extended modulator to the other side (upper extremity in FIG. 7). One side of the extended modulator may correspond to one edge of the field of view (e.g. negative 20 degrees) and the other side may correspond to the other edge of the field of view (e.g.

positive 20 degrees). The reader will be familiar with the idea that the waveguide provides replication in one dimension (e.g. the vertical direction) and the so the one edge may correspond to the top of the image and the other edge may correspond to the bottom of the image. The reader will be familiar that the present disclosure encompasses systems in which two orthogonal waveguides are used to provide replication/pupil expansion in two perpendicular directions e.g. horizontal and vertical. FIG. 7 shows one-dimensional replication only for the sake of simplicity.

FIG. 7 shows three example light ray bundles travelling from the extended modulator to the viewer 804. A first light ray bundle 806 corresponds to the top of the field of view and represents significant overlap between adjacent replicas (in angular terms). Therefore, both replicas corresponding to the first light ray bundle 806 provide the light ray angles shown to the viewer 804. This results in the perception of a bright band of light. In embodiments in which the hologram divides the spatial content of the image by angle in the hologram domain (i.e. the domain between the extended modulator and the viewer) this bright band corresponds to a positive reinforce of a strip or line of the image. That is, whilst the viewer does not perceive the presence of replicas and overlap therebetween, the parts of the image encoded by the overlapping light ray angles of the first light ray bundle 806 result in a bright band (in the spatial domain) in the perceived image reconstructed by the viewer 804. In other words, the band or strip of the image (corresponding to the angles of the holographic wavefront of the first light ray bundle 806) is brighter than other areas of the image that do not correspond to an angular overlap.

A second light ray bundle 808 is shown in the FIG. 7. The second light ray bundle 808 is smaller than the first light ray bundle 806 in angular terms and therefore the corresponding bright band in the perceived image is smaller in spatial terms. The range of light ray angles in the second light ray bundle 808 is less than that of the first light ray bundle 806. A third light ray bundle 810 may comprise a minimum, or even zero, angular overlap.

Consequently, an array of parallel, bright bands are perceived in the image. These bright bands extend in a direction perpendicular to the direction of replication. The thickness or width of each successive bright band decreases from the top of field of field to the bottom owing to a decrease in the angular overlap between replicas from top to bottom (in the geometry of FIG. 7). These bright bands have a negative effect on the viewing experience. The present disclosure addresses this problem.

Some embodiments use a Gerchberg-Saxon based algorithm to generate a Fourier hologram and applying constrains to turn off unwanted angles (of the holographic wavefront). Advantageously, this is a pure software solution to remove the horizontal bright lines.

Owing to the way the hologram routes light in accordance with this disclosure, limiting the content in the target during the iterative loops of the algorithm effectively limits the angles at which the hologram diffracts light, making it possible to remove bright lines in Fourier hologram.

In summary, the method devised by the inventors comprises the following steps:
(1) calibration to measure how large (i.e. the height) of the overlap regions for different vertical viewing angles. This may be performed experimentally or by simulation.
(2) Splitting the vertical field of view into a number of zones (for example, four zones) and computing a Fourier hologram, using a Gerchberg-Saxton based loop, for each zone using the corresponding target image. The result is four Fourier hologram each of which diffracts light in a certain range of angles.
(3) Using the information from Step 1, turning the pixels in the overlap regions off by nulling the corresponding pixels such as setting the corresponding pixels to black (or setting the phase value to zero).
(4) The holograms from Step 3 can be displayed as subframes in a time sequence mode (e.g. 3×video rate). Alternatively, they can be summed up in complex field to obtain one single hologram.

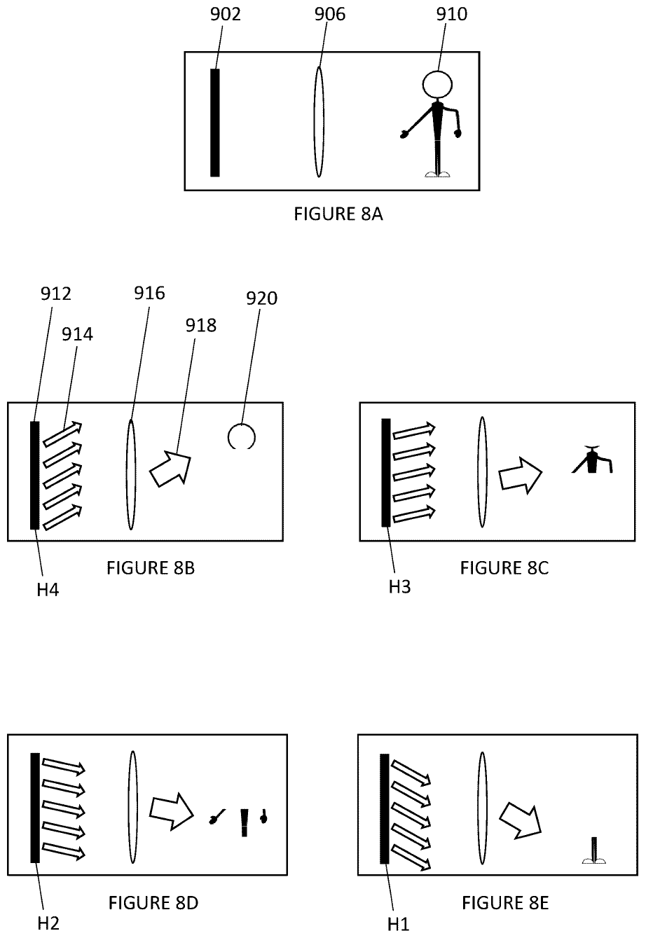

### This approach is described more fully in the following with reference to FIGS. 8 to 10.

FIG. 8A shows a Fourier hologram 902, a lens 906 arranged to perform a Fourier transform and an image or holographic reconstruction 910. The hologram 902 encodes an image of a person 910. A hologram 902 of a target image of the person is determined by any known technique. In some embodiments, the hologram 902 is a Fourier transform determined by an iterative phase retrieval algorithm such as one based on the Gerchberg-Saxton algorithm.
FIG. 8A shows a conventional arrangement in which the hologram 902 encoded the entire field of view—that is, all of the person. FIGS. 8B to 8E represent an embodiment of the present disclosure. In accordance with embodiments of the present disclosure, the field of view is divided into a plurality of zones or areas or strips. In the embodiment of FIGS. 8B to 8E, the target image is divided into four even horizontal strips. A hologram of each strip of the image is determined. A first hologram, H1, therefore encodes a lower portion of the field of view. A second hologram, H2, encodes a lower-middle portion of the field of view and a third hologram, H3, encodes an upper-middle portion of the field. A fourth hologram, H4, encodes an upper portion of the field of view.

FIG. 8B shows a Fourier hologram 912 (which is the fourth hologram, H4, of the above description), a lens 916 arranged to perform a Fourier transform and a corresponding image 920 or holographic reconstruction. In the embodiment of FIGS. 8B to 8E, the hologram divides/encodes the image content in the spatial domain by angle in the hologram domain (between the hologram and respective Fourier transform lens) and so each hologram effectively channels light (i.e. the holographic wavefront) in accordance with the corresponding part of the field of view. FIG. 8 show Fourier holography by way of example only and, for the avoidance of doubt, the present disclosure is effective with other types of hologram where there is a one-to-one correlation between parts of the image in the spatial domain and angles in the hologram domain. Arrow 918 in FIG. 8B represents the direction of light (in the spatial domain/after the Fourier transform optic) towards the corresponding part of the image.

In some embodiments, each hologram H1-H4 is formed by nulling (e.g. zeroing) pixel values outside of the image zone. Therefore, the size (more specifically, number of pixels) of the target image and hologram is not therefore reduced. That is, the number of pixels of the target image used to determine each of H1-H4 is the constant, and the same as that represented by FIG. 8A.

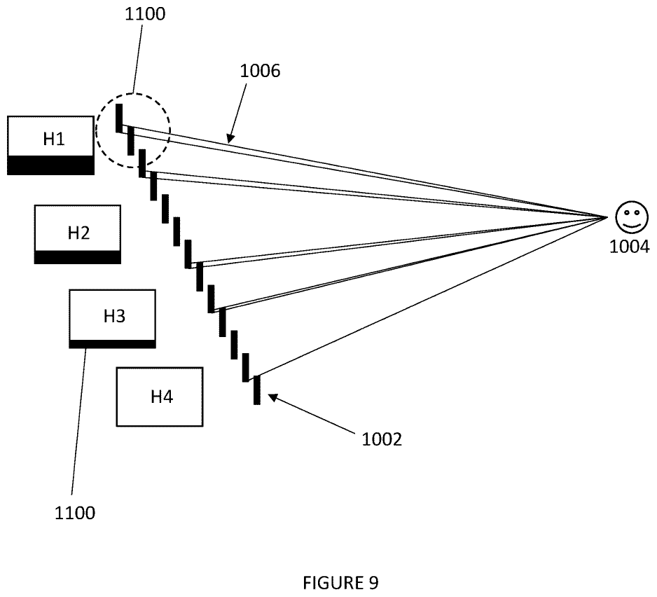

FIG. 9 shows a viewer 1004 arranged to receive a holographic wavefront, represented by some example light ray bundles such as first light ray bundle 1006, from an extended modulator 1002 in accordance with this disclosure. In some embodiments, the plurality of holograms H1-H4 are time-interlaced—that is, there are display (and illuminated) one by one in quick succession such as within the integration time of the human eye. In some embodiments, the entire extended modulator (and therefore the entire surface or output port of the waveguide) is used to deliver the image content to the viewer 1004. In some embodiments, all replicas deliver a portion of the field of view/image to the viewer 1004.

There is a correlation between spatial positions on the waveguide and angles of the field of view. For example, when the viewer 1004 looks at one end of the waveguide, they see one end (e.g. the top) of the field of view and when they look at the other end of the waveguide, they see the other end (e.g. bottom) of the field of view. Therefore, the trend of a change in hologram overlap with distance along the waveguide shown by arrow 840 in FIG. 7 can be compensated using the interlacing/hologram division scheme, as explained in the following. As shown by FIG. 9, when the viewer 1004 looks at the top of the waveguide/extended modulator 1002, they should see the top of the field of view which may be the head of the person (holographic reconstruction 910) shown in FIG. 8. The hologram replica overlap associated with the top of the waveguide/extended modulator 1002 is a maximum.

Therefore, when hologram H1 is displayed a maximum amount of hologram cropping/pixel nulling is used.

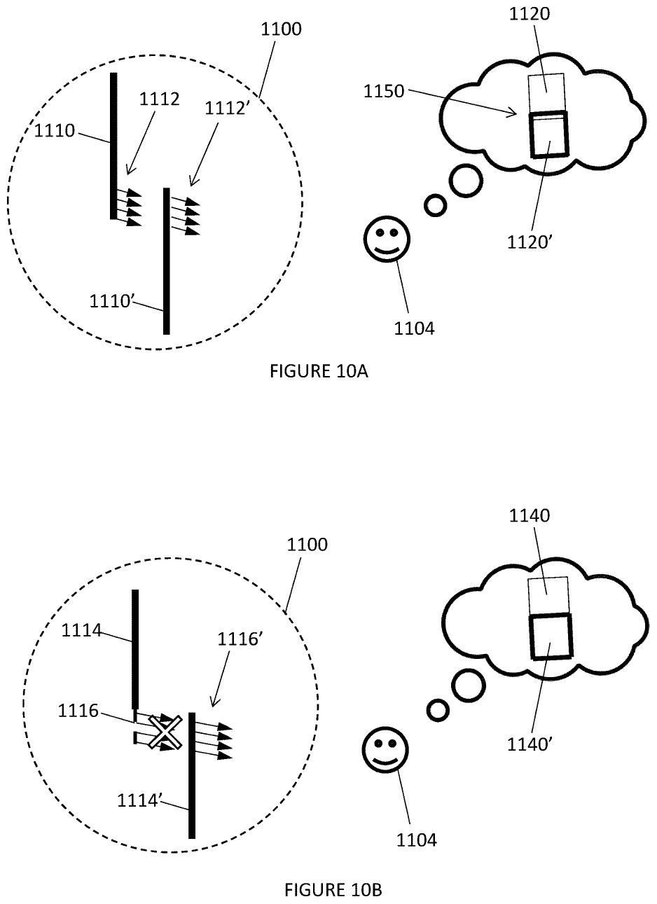

FIGS. 10A and 10B show the effect of nulling pixels of hologram H1. FIG. 10A shows how the overlap with two replicas results in the duplication of angular content in the holographic wavefront, and therefore the duplication of image content in bands in the spatial domain leading to bright bands. Specifically, FIG. 10A shows how a back (with respect to the viewer 1104) hologram replica 1110 delivers angular content which is also delivered by a front replica 1110′ and shown as angular content. The overlapping angular content is represented by light ray bundles 1112 and 1112′. These light ray bundles correspond to the same angle of the holographic wavefront (in the hologram domain) and therefore correspond to the same spatial region (specifically, band) of the image (in the spatial domain). FIG. 10A shows how the viewer 1104 perceives a reinforced/bright band 1150 where a first image area 1120 corresponding to the back hologram replica 1110 and a second image area 1120′ corresponding to the front hologram replica 1110′ overlap.

The present disclosure using a principle of pixel nulling to eliminate the angular duplication shown in FIG. 10A. The principle is illustrated in FIG. 10B which largely corresponds to FIG. 10A. The reinforced/bright band 1150 is eliminated by nullifying the lower part of the hologram. This shown by nullified area 1116 of the rear replica 1114. By nullifying this area of the hologram, angular content 1116′ delivered to the viewer 1104 by the front replica 111′ is not also delivered by the rear replica 1114. There is therefore no overlap between the first image area 1140 corresponding to the back hologram replica 1114 and the second image area 1140′ corresponding to the front hologram replica 1114′. For the avoidance of doubt, the nullified area is also present in the front replica (because the replicas are all the same) but it is not shown in FIG. 10B for ease of illustration.

Returning to FIG. 9, in accordance with the present disclosure, the different holograms use different size null regions. As shown in FIG. 9, the size of the null area (of the hologram) represented by the dark zone decreases with distance along the waveguide. FIGS. 8 and 9 shown the image being split into four horizontal areas by way of example only and any number of areas may be used. Notably, the inventors devised this scheme in order to ensure that angular content is not lost. This can be understood with reference to H4 which corresponds to the minimum, or even zero, replica overlap. If the lower portion of H4 were nullified, there would be angular content (i.e. some light ray angles) that does not get to the viewer 1004 from any replica. The inventors therefore recognised that viewing experience is further improved if the magnitude of the pixel nulling is reduced with distance along the waveguide. Again, the lower part of the waveguide corresponds to the lower part of the field of view/angle and so dividing the image as shown in FIG. 8 and using time interlacing allows the degree of pixel nulling to be tuned/optimised based on angle in the field of view.

### Additional Features

In embodiments, the holographic reconstruction is colour. In some embodiments, an approach known as spatially-separated colours, “SSC”, is used to provide colour holographic reconstruction. In other embodiments, an approach known as frame sequential colour, “FSC”, is used.

Examples describe illuminating the SLM with visible light but the skilled person will understand that the light sources and SLM may equally be used to direct infrared or ultraviolet light, for example, as disclosed herein. For example, the skilled person will be aware of techniques for converting infrared and ultraviolet light into visible light for the purpose of providing the information to a user. For example, the present disclosure extends to using phosphors and/or quantum dot technology for this purpose.

Some arrangements describe 2D holographic reconstructions by way of example only. In other arrangements, the holographic reconstruction is a 3D holographic reconstruction. That is, in some arrangements, each computer-generated hologram forms a 3D holographic reconstruction.

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

1. A display system having a viewing window, wherein the display system comprises:
a hologram replicator arranged to waveguide a holographic wavefront between a pair of reflective surfaces, wherein a first reflective surface is partially transmissive such that a plurality of replicas of the holographic wavefront are emitted therefrom;
a hologram engine arranged to output holograms that distribute picture content of a corresponding picture by angle such that a spatial coordinate in the picture corresponds to an angle in a holographic wavefront formed from each hologram; and
wherein the hologram engine is further arranged to: (i) determine a plurality of sub-holograms of the picture, wherein each sub-hologram corresponds to a different zone of the picture; and (ii) nullify an area of each sub-hologram, wherein a size of the nullified area is different for each sub-hologram.

2. The display system of claim 1, wherein the zones evenly divide the picture in a first direction.

3. The display system of claim 2, wherein each nullified area is a strip of each sub-hologram extending in a same direction as the zone of the corresponding picture.

4. The display system of claim 2, wherein the size of the nullified area decreases with each successive zone of the picture, or vice versa.

5. The display system of claim 1, wherein each replica of the holographic wavefront corresponds to a respective hologram replica of a staggered array of hologram replicas formed by the hologram replicator, wherein the staggered array of hologram replicas extends in a first direction.

6. The display system of claim 5 wherein each successive hologram replica of the staggered array of hologram replicas is closer to the viewing window than the last.

7. The display system of claim 1, wherein the size of the nullified area corresponds to the size of an angular overlap between adjacent hologram replicas from a viewing position within the viewing window.

8. The display system of claim 1, wherein a sub-hologram comprises pixels, and wherein the nullified area comprises no more than 20% of the pixels of the sub-hologram.

9. The display system of claim 1, wherein a sub-hologram comprises pixels, and wherein a change in the size of the nullified area from one sub-hologram of the picture to a next sub-hologram corresponds to no more than 5% of the pixels of the sub-hologram.

10. The display system of claim 1, wherein the hologram replicator replicates the hologram in a first direction.

11. The display system of claim 1, wherein the hologram engine is arranged to determine a size of the nullified area of each sub-hologram based on a viewing position within the viewing area.

12. The display system of claim 11 further comprising a user-tracking system arranged to determine the viewing position.

13. The display system of claim 1, wherein the hologram engine is arranged to output each sub-hologram in turn within an integration time of a human eye.

14. The display system of claim 1, wherein the hologram engine is arranged to calculate each sub-hologram using an iterative phase retrieval algorithm.

15. A head-up display comprising a display system, of wherein the display system comprises:
a viewing window;
a hologram replicator arranged to waveguide a holographic wavefront between a pair of reflective surfaces, wherein a first reflective surface is partially transmissive such that a plurality of replicas of the holographic wavefront are emitted therefrom;
a hologram engine arranged to output holograms that distribute picture content of a corresponding picture by angle such that a spatial coordinate in the picture corresponds to an angle in a holographic wavefront formed from each hologram; and
wherein the hologram engine is further arranged to: (i) determine a plurality of sub-holograms of the picture, wherein each sub-hologram corresponds to a different zone of the picture; and (ii) nullify an area of each sub-hologram, wherein a size of the nullified area is different for each sub-hologram.

16. The head-up display of claim 15, wherein each replica of the holographic wavefront corresponds to a respective hologram replica of a staggered array of hologram replicas formed by the hologram replicator, wherein the staggered array of hologram replicas extends in a first direction.

17. The head-up display of claim 15, wherein the size of the nullified area corresponds to the size of an angular overlap between adjacent hologram replicas from a viewing position within the viewing window.

18. The head-up display of claim 15, wherein the hologram engine is arranged to determine a size of the nullified area of each sub-hologram based on a viewing position within the viewing area.

19. The head-up display of claim 15, wherein the hologram engine is arranged to determine a size of the nullified area of each sub-hologram based on a viewing position within the viewing area, and wherein the head-up display further comprises a user-tracking system arranged to determine the viewing position.

20. The head-up display of claim 15, wherein the hologram engine is arranged to output each sub-hologram in turn within an integration time of a human eye.
